(19) United States
(12) Patent Application Publication
(10) Pub. No.: US 2025/0131301 A1
(43) Pub. Date: Apr. 24, 2025

(54) GATE REDUCTION AT DISTRIBUTED EDGE DEVICES OR OTHER DEVICES

(71) Applicant: Raytheon Company, Tewksbury, MA (US)

(72) Inventors: Paul C. Hershey, Ashburn, VA (US); Vikram A. Prasad, Irvine, CA (US); Marcus A. Teter, Belgrade, MT (US); Brianne R. Hoppes, Westminster, CO (US); Michael T. Bahns, Tucson, AZ (US)

(21) Appl. No.: 18/816,736

(22) Filed: Aug. 27, 2024

Related U.S. Application Data
(60) Provisional application No. 63/591,954, filed on Oct. 20, 2023.

(51) Int. Cl. G06N 10/20

(52) U.S. Cl. CPC G06N 10/20

(57) ABSTRACT

A method includes obtaining, using at least one processing device of an electronic device, information defining a combinatorial logic gate design for a combinatorial logic circuit. The method also includes generating, using the at least one processing device, one or more polynomials representing operation of the combinatorial logic gate design. The method further includes mapping, using the at least one processing device, the one or more polynomials to one or more quantum polynomials, where each quantum polynomial has terms that are orthonormal. In addition, the method includes generating, using the at least one processing device, a quantum gate logic design based on the one or more quantum polynomials, where the quantum gate logic design is functionally equivalent to or better than the combinatorial logic gate design for the combinatorial logic circuit.

### CROSS-REFERENCE TO RELATED APPLICATION AND PRIORITY CLAIM

This application claims priority under 35 U.S.C. § 119 (e) to U.S. Provisional Patent Application No. 63/591,954 filed on Oct. 20, 2023. This provisional application is hereby incorporated by reference in its entirety.

### TECHNICAL FIELD

This disclosure is generally directed to quantum circuit designs. More specifically, this disclosure is directed to gate reduction at distributed edge devices or other devices.

### BACKGROUND

There are numerous circumstances in which device designers and manufacturers would like to additional functionalities to their devices. In many instances, this might be accomplished by simply adding additional circuitry to various devices. However, in various instances, devices are limited in terms of size, weight, power, and cost (SWaP-C), so adding additional circuitry to those devices may not be possible.

### SUMMARY

This disclosure relates to gate reduction at distributed edge devices or other devices.

In a first embodiment, a method includes obtaining, using at least one processing device of an electronic device, information defining a combinatorial logic gate design for a combinatorial logic circuit. The method also includes generating, using the at least one processing device, one or more polynomials representing operation of the combinatorial logic gate design. The method further includes mapping, using the at least one processing device, the one or more polynomials to one or more quantum polynomials, where each quantum polynomial has terms that are orthonormal. In addition, the method includes generating, using the at least one processing device, a quantum gate logic design based on the one or more quantum polynomials, where the quantum gate logic design is functionally equivalent to or better than the combinatorial logic gate design for the combinatorial logic circuit.

In a second embodiment, an apparatus includes at least one processing device configured to obtain information defining a combinatorial logic gate design for a combinatorial logic circuit and generate one or more polynomials representing operation of the combinatorial logic gate design. The at least one processing device is also configured to map the one or more polynomials to one or more quantum polynomials, where each quantum polynomial has terms that are orthonormal. The at least one processing device is further configured to generate a quantum gate logic design based on the one or more quantum polynomials, where the quantum gate logic design is functionally equivalent to or better than the combinatorial logic gate design for the combinatorial logic circuit.

In a third embodiment, a non-transitory machine readable medium contains instructions that when executed cause at least one processor to obtain information defining a combinatorial logic gate design for a combinatorial logic circuit and generate one or more polynomials representing operation of the combinatorial logic gate design. The non-transitory machine readable medium also contains instructions that when executed cause the at least one processor to map the one or more polynomials to one or more quantum polynomials, where each quantum polynomial has terms that are orthonormal. The non-transitory machine readable medium further contains instructions that when executed cause the at least one processor to generate a quantum gate logic design based on the one or more quantum polynomials, where the quantum gate logic design is functionally equivalent to or better than the combinatorial logic gate design for the combinatorial logic circuit.

In a fourth embodiment, an edge device includes a quantum circuit implementing a quantum gate logic design for a combinatorial logic circuit based on one or more quantum polynomials, where each quantum polynomial has terms that are orthonormal. The one or more quantum polynomials have been mapped to one or more polynomials representing operation of the combinatorial logic gate design for the combinatorial logic circuit. The quantum gate logic design is functionally equivalent to or better than the combinatorial logic gate design for the combinatorial logic circuit.

Any single one or any suitable combination of the following features may be used with the first, second, third, or fourth embodiment. The one or more quantum polynomials may be mapped into Hilbert space. A minimal coefficient representation of the combinatorial logic gate design in Hilbert space may be determined by dropping terms from the one or more quantum polynomials having zeros as coefficients. The one or more polynomials representing the operation of the combinatorial logic gate design may be generated by generating a regular expression representing the operation of the combinatorial logic gate design, applying gate optimization to generate a reduced expression based on the regular expression, and generating the one or more polynomials representing the operation of the combinatorial logic gate design based on the reduced expression. Information defining the combinatorial logic gate design may be obtained and the one or more polynomials representing the operation of the combinatorial logic gate design may be generated by obtaining an image having multiple pixels, generating polynomials based on the pixels, selecting a subset of the polynomials, and using the subset of the polynomials to generate the combinatorial logic gate design. The one or more polynomials may be mapped to the one or more quantum polynomials by mapping the subset of the polynomials to orthonormal functions and normalizing rational number coefficients of the orthonormal functions. The quantum gate logic design may be used to determine whether an object of interest as captured in a first image is present in a second image. The quantum gate logic design may be functionally equivalent to or better than the combinatorial logic gate design for the combinatorial logic circuit based on a comparison of at least one of: inputs, outputs, numbers of gates, sizes, weights, processing powers, or speeds.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting gate reduction at distributed edge devices or other devices according to this disclosure;

FIG. 2 illustrates an example device supporting gate reduction at distributed edge devices or other devices according to this disclosure;

FIG. 3 illustrates an example functional architecture supporting gate reduction at distributed edge devices or other devices according to this disclosure;

FIG. 4 illustrates an example representation of a specific linear sequential machine in the form of a shift register according to this disclosure;

FIG. 5 illustrates an example functional architecture supporting gate reduction at distributed edge devices or other devices in order to support a particular image processing function according to this disclosure;

FIGS. 6A and 6B illustrate example operations in the architecture of FIG. 5 according to this disclosure; and

FIG. 7 illustrates an example method for gate reduction at distributed edge devices or other devices according to this disclosure.

### DETAILED DESCRIPTION

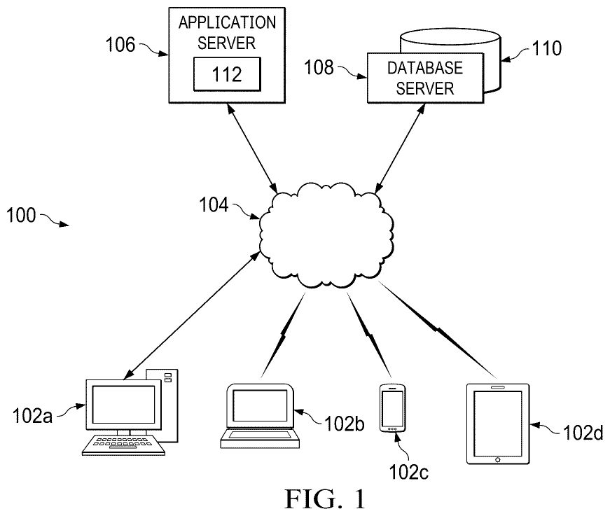

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, there are numerous circumstances in which device designers and manufacturers would like to additional functionalities to their devices. In many instances, this might be accomplished by simply adding additional circuitry to various devices. However, in various instances, devices are limited in terms of size, weight, power, and cost (SWaP-C), so adding additional circuitry to those devices may not be possible. As a particular example of this, in a complex multi-domain battlespace, Distributed and Disaggregated Command and Control (D2C2) entities and assets located at the “edge” (such as satellites, drones, or other air, land, sea, or space platforms) may need to perform a greater portion of processing tasks, which might typically require the use of additional circuitry. However, satellites, drones, and other battlespace platforms are often SWaP-C limited, so simply adding additional circuitry to those platforms may not be possible.

In these or other cases, one typical approach for incorporating new functionalities into devices involves reducing the circuitry required to perform existing or additional functions. The reduction in the circuitry may allow the new functionalities to be introduced into devices while still satisfying SWAP-C requirements for those devices. Traditionally, circuit reduction is accomplished through logic gate reduction, which can be achieved using combinatorial logic gate designs that are based on algebraic mathematics or graph theoretical approaches. However, these approaches for circuit reduction may not be sufficient for emerging complexities.

This disclosure provides various techniques for gate reduction at distributed edge devices or other devices. As described in more detail below, this disclosure provides techniques for reducing the size and complexity of processing or other circuitry for various devices (such as air, land, sea, or space platforms) by combining optimization principles of traditional and quantum gate designs in order to realize practical quantum-based circuit designs. Among other things, this can be achieved using one or more novel algorithms that transform vectors representing traditional combinatorial logic designs (such as classical gate patterns) into orthonormal eigen-vectors in Hilbert space (such as Legendre or Laguerre polynomials) representing quantum gate designs. This can also be achieved using one or more novel algorithms that transform traditional combinatorial logic designs and associated gate optimizations into optimized quantum logic-gate designs that can be practically implemented in one or more quantum technologies, such as photonic logic devices.

In this way, the described techniques can use a combination of traditional combinatorial gate design principles and distributed quantum computing gate principles in order to achieve greater circuit reductions. As a result, it is possible to create practical quantum-based circuit designs for edge devices and other devices that greatly reduce or minimize the size, weight, power, and/or cost of the resulting devices. This allows more processing tasks or other tasks to be performed using those devices while still satisfying any SWaP-C requirements on those devices. In complex multi-domain battlespaces, for instance, this allows edge devices (like SWaP-C limited satellites, drones, or other platforms) to perform greater portions of on-mission processing tasks. Moreover, in some cases, quantum logic-gate designs that are implemented using various quantum technologies (like photonic logic devices) may be dynamically updateable based on changing conditions. In addition, the described techniques may support the guaranteed identification of minimal coefficient representations of digital circuits (if they exist), which can be even better than theoretical results achievable using traditional Finite State Machine (FSM) theory.

Note that the techniques described in this patent document may find use in designing any number of devices for any number of applications. For example, it has already been noted that the described techniques may be used to design circuitry for satellites, drones, and other air, land, sea, or space platforms, such as D2C2-based platforms. A particular example may include designing circuitry to support integrated data processing capabilities (such as sensing, collection, and distribution) for small or low SWaP-C satellites, such as operating constellations of satellites that require or desire real-time data synchronization. The described techniques may be used to create designs for medical devices, such as embedded medical monitors that may require or desire small SWaP-C processing. Particular examples may include asynchronous fibrillation monitors and pacemakers. The described techniques may be used to create designs to support expanded sensor processing in autonomous vehicles, such as autonomous passenger vehicles, drones that deliver products to customers, or railway safety vehicles. The described techniques may be used to create designs to support additional monitoring and reporting functions for law enforcement-based platforms, such as drones used for border control or maritime domain awareness or tracking devices used for tracking actual or suspect criminals. In general, this disclosure is not limited to use with any specific type(s) of device(s) or any specific application(s).

FIG. 1 illustrates an example system 100 supporting gate reduction at distributed edge devices or other devices according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the analysis of circuit-related information and the use of both traditional combinatorial gate design principles and distributed quantum computing gate principles in order to perform circuit reductions. This allows the application server 106 to create practical quantum-based circuit designs for edge devices and other devices. For example, one or more applications 112 may be configured to retrieve information from the database 110 via the database server 108 for processing and/or provide information to the database 110 via the database server 108 for storage. As particular examples, the retrieved information may include circuit-related information, and the provided information may include quantum-based circuit designs. Example functions of the application(s) 112 related to performing circuit reductions are provided below.

The database server 108 operates to store and facilitate retrieval of various information used, generated, or collected by the application server 106 and the user devices 102a-102d in the database 110. For example, the database server 108 may store various information in relational database tables or other data structures in the database 110. Note that the database server 108 may also be used within the application server 106 to store information, in which case the application server 106 may store the information itself.

Although FIG. 1 illustrates one example of a system 100 supporting gate reduction at distributed edge devices or other devices, various changes may be made to FIG. 1. For example, the system 100 may include any number of user devices 102a-102d, networks 104, application servers 106, database servers 108, and databases 110. Also, these components may be located in any suitable locations and might be distributed over a large area. In addition, while FIG. 1 illustrates one example operational environment in which gate reduction at distributed edge devices or other devices may be used, this functionality may be used in any other suitable system.

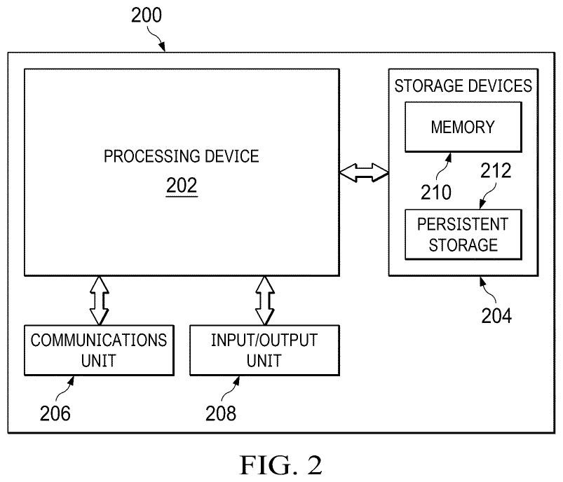

FIG. 2 illustrates an example device 200 supporting gate reduction at distributed edge devices or other devices according to this disclosure. One or more instances of the device 200 may, for example, be used to at least partially implement the functionality of the application server 106 of FIG. 1. However, the functionality of the application server 106 may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the functionality of the application(s) 112 for performing circuit reductions. Thus, for example, the instructions when executed by the processing device 202 may cause the device 200 to obtain circuit-related information and use both traditional combinatorial gate design principles and distributed quantum computing gate principles in order to perform circuit reductions.

Although FIG. 2 illustrates one example of a device 200 supporting gate reduction at distributed edge devices or other devices, various changes may be made to FIG. 2. For example, computing and communication devices and systems come in a wide variety of configurations, and FIG. 2 does not limit this disclosure to any particular computing or communication device or system.

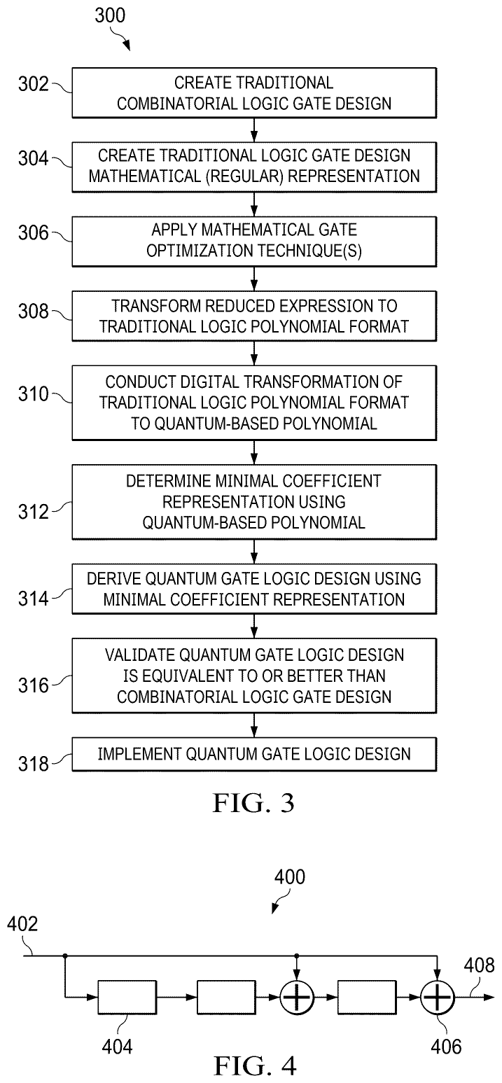

FIG. 3 illustrates an example functional architecture 300 supporting gate reduction at distributed edge devices or other devices according to this disclosure. For ease of explanation, the functional architecture 300 shown in FIG. 3 may be described as being implemented on or supported by one or more components in the system 100 of FIG. 1, such as when the functional architecture 300 is implemented using the application server 106 (which itself may be implemented using one or more instances of the device 200 of FIG. 2). As a particular example, the functional architecture 300 may be implemented using one or more applications 112 executed by the processing device(s) 202 of the device(s) 200 forming the application server 106. However, the functional architecture 300 shown in FIG. 3 may be implemented on or supported by any suitable device(s) and in any suitable system(s).

As shown in FIG. 3, the functional architecture 300 includes a creation function 302 that involves the creation of a traditional combinatorial logic gate design. The creation function 302 generally operates to produce a design for a combinatorial logic circuit, where the combinatorial logic circuit is formed using various combinatorial logic gates that are coupled together to perform at least one desired function. The specific combinatorial logic gates and their associated connections can vary widely based on the function or functions to be performed by the combinatorial logic circuit. The traditional combinatorial logic gate design can be defined in any suitable manner. For example, the creation function 302 may receive data defining the combinatorial logic gates and their associated connections, or the creation function 302 may obtain a portable document format (PDF) document or other document that graphically illustrates the combinatorial logic gates and their associated connections and use image processing or other techniques to process the document and recognize the combinatorial logic gates and their associated connections. There are various approaches that may be used for creating a traditional combinatorial logic gate design for a circuit. In general, this disclosure is not limited to any specific technique(s) for creating traditional combinatorial logic gate designs.

The traditional combinatorial logic gate design is provided to a creation function 304, which generally operates to process the traditional combinatorial logic gate design and generate a traditional logic gate design mathematical expression representing the operation(s) of the traditional combinatorial logic gate design. For example, the creation function 304 may generate a regular expression that mathematically represents the operation(s) of the traditional combinatorial logic gate design. The regular expression can represent a mathematical expression that defines the output(s) of the traditional combinatorial logic gate design based on (i) the input(s) to the traditional combinatorial logic gate design and (ii) the specific combinatorial logic gates and connections included in the traditional combinatorial logic gate design. There are various approaches that may be used for creating a regular expression representing a traditional combinatorial logic gate design for a circuit. In general, this disclosure is not limited to any specific technique(s) for creating regular expressions for traditional combinatorial logic gate designs.

The regular expression is provided to an optimization function 306, which generally operates to apply one or more mathematical gate optimization techniques using the regular expression in order generate a simplified or reduced regular expression. The reduced regular expression can still represent the same operation(s) of the traditional combinatorial logic gate design as the original regular expression. However, the reduced regular expression can include fewer terms and operations, which can often be achieved by combining and/or moving terms and/or operations in the original regular expression so that the original regular expression can be mathematically simplified. Effectively, the optimization function 306 can perform gate reduction in order to reduce the number of combinatorial logic gates (and typically the number of associated connections involving the combinatorial logic gates) based on the simplification. There are various approaches that may be used for performing gate reduction or otherwise performing regular expression simplification. In general, this disclosure is not limited to any specific technique(s) for performing gate reduction or otherwise performing regular expression simplification.

The reduced regular expression is provided to a transformation function 308, which generally operates to convert the reduced regular expression into at least one polynomial. Each polynomial has a general polynomial format as follows.

$$P ( x ) = {a}_{0} + {a}_{1} x + {a}_{2} {x}^{2} + … + {a}_{n - 1} {x}^{n - 1} + {a}_{n} {x}_{n}$$

Here, each processing level of combinatorial logic gates represented by the simplified regular expression may be associated with a different degree of x in the above equation. In other words, one processing level of combinatorial logic gates can be associated with x, another processing level of combinatorial logic gates can be associated with x², yet another processing level of combinatorial logic gates can be associated with x³, and so on. There are various approaches that may be used for converting reduced regular expressions into polynomials. For example, linear sequential machines are a particular type of system that can be represented using a polynomial. An example of a linear sequential machine is a linear shift register, which can be represented using the following polynomial.

$$z = {a}_{0} x + {a}_{1} D x + … + {a}_{n} {D}^{n} x$$

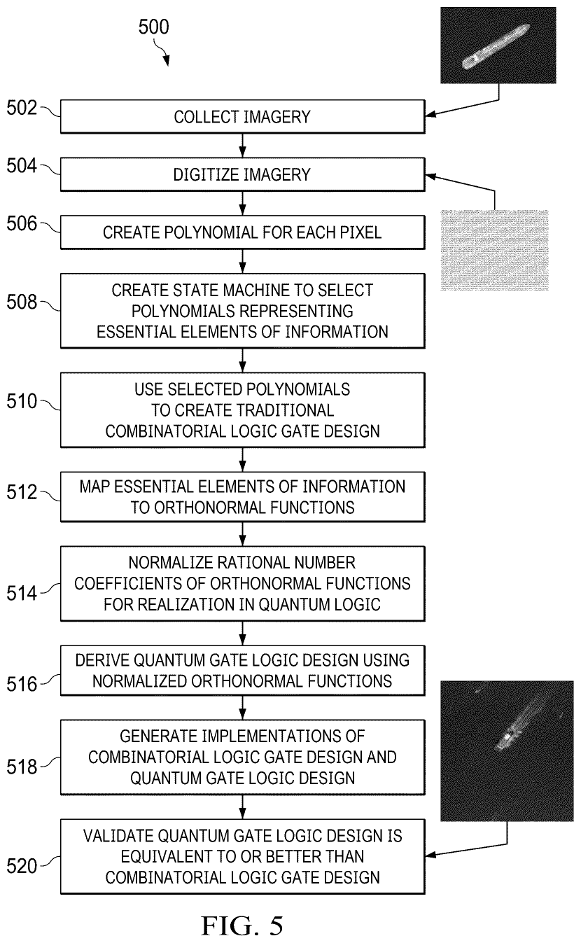

FIG. 4 illustrates an example representation 400 of a specific linear sequential machine in the form of a shift register according to this disclosure. As shown in FIG. 4, the representation 400 indicates that an input 402 is processed using delay units 404 and modulo two adders 406 in order to generate an output 408. This type of feed-forward shift register may be defined using the following polynomial.

$$z = 1 + D + {D}^{3}$$

It is known that conditions under which a reduced sequential machine can be linearly realizable enable the application of the Euclidean algorithm in order to determine the greatest common divisor for a polynomial. It is also possible to mathematically characterize more complex circuits using polynomials that represent the subcomponents of the more complex circuits, such as when a binary adder is characterized using polynomials that include one or more feed-forward shift registers (which can be a component of the binary adder). Thus, these techniques can be used to mathematically characterize any complex circuit by breaking the circuit down into its smaller subcomponents.

The at least one polynomial representing the reduced regular expression is provided to a digital transformation function 310, which generally operates to convert the polynomial(s) representing the traditional logic gate design into at least one quantum-based polynomial. Each quantum-based polynomial represents a polynomial in which the terms of the polynomial are orthonormal to one another. For example, the transformation function 310 may convert the polynomial(s) representing the traditional logic gate design into one or more Legendre or Laguerre polynomials. This conversion can also move from the original space of the polynomial(s) representing the traditional logic gate design into Hilbert space. As an example of this, the transformation function 310 may convert the polynomial(s) representing the traditional logic gate design into eigen-vectors in Hilbert space.

As a particular example of this approach, it is possible to map a tradition polynomial of degree n into a Legendre polynomial of degree n. For instance, a third-degree tradition polynomial may be converted into a third-degree Legendre polynomial having the following form.

$$P ( x ) = {a}_{0} {L}_{0} + {a}_{1} {L}_{1} + {a}_{2} {L}_{2} + {a}_{3} {L}_{3}$$

### Here:

$${a}_{3} = \frac{2 {A}_{0}}{3}$$

$${a}_{2} = \frac{- 2 {A}_{1}}{3}$$

$${a}_{1} = - ( {A}_{2} - \frac{3 {A}_{0}}{5} )$$

$${a}_{0} = - ( {A}_{3} + \frac{2 {A}_{1}}{3} ) + 1$$

In this example, there will be a maximum of four terms {L₃, L₂, L₁, L₀} defining the Legendre polynomial, and those terms are orthonormal. If any of the {a₃, a₂, a₁, a₀} coefficients is zero, the order of the Legendre polynomial can decrease. This is possible since Legendre polynomials can satisfy the following differential equation.

$$( 1 - {x}^{2} ) \frac{{d}^{2} y}{d {x}^{2}} - 2 x \frac{d y}{d x} + [ v ( v + 1 ) ] y = 0$$

Here, v represents the order of the Legendre polynomial. A third-degree Legendre polynomial can form a two-dimensional Hilbert space, where any subspace of the Hilbert space is also a Hilbert space.

In some embodiments, the following code may be used to convert a tradition polynomial of up to three degrees into a Legendre polynomial of up to three degrees.

```
if degree == 0:
  output.write(str(pd[0]/(np.sqrt(np.square(pd[0])))) + ′ ′)
if degree == 1:
  output.write(str(pd[0]/(np.sqrt(np.square(pd[0])+np.square(pd[1])))) + ′ ′ +
  str(pd[1]/(np.sqrt(np.square(pd[0])+np.square(pd[1])))) + ′ ′)
if degree == 2:
  output.write(str(pd[0]/(np.sqrt(np.square(pd[0])+np.square(pd[1])+np.square(pd[2]))))
  + ′ ′ + str(pd[1]/(np.sqrt(np.square(pd[0])+np.square(pd[1])+np.square(pd[2])))) + ′ ′
  + str(pd[2]/(np.sqrt(np.square(pd[0])+np.square(pd[1])+np.square(pd[2])))) + ′ ′)
if degree == 3:
  output.write(str(pd[0]/(np.sqrt(np.square(pd[0])+np.square(pd[1])+np.square(pd[2]) +
  np.square(pd[3])))) + ‘ ‘ +
  str(pd[1]/(np.sqrt(np.square(pd[0])+np.square(pd[1])+np.square(pd[2])+
  np.square(pd[3])))) + ′ ′ +
  str(pd[2]/(np.sqrt(np.square(pd[0])+np.square(pd[1])+np.square(pd[2])+
  np.square(pd[3])))) + ′ ′ +
  str(pd[3]/(np.sqrt(np.square(pd[0])+np.square(pd[1])+np.square(pd[2])+
  np.square(pd[3])))) + ′ ′)
```

The code here can be extended to handle polynomials of orders higher than three. The at least one quantum-based polynomial is provided to a determination function 312, which generally operates to determine a minimal coefficient representation of the traditional logic gate design using the quantum-based polynomial(s). In some cases, the determination function 312 can depend on the fact that a subspace of a Hilbert space is also a Hilbert space. As a result, instead of carrying forward vectors with values for all polynomial coefficients into future calculations, vectors with values for only the non-zero polynomial coefficients may be needed. Because of this, once it is established that a Hilbert space representation includes zero and non-zero entries, vectors with values corresponding to only the non-zero entries may need to be carried forward in subsequent calculations. This is a form of lossless compression as long as it is known which components are being carried forward. This may also include the determination function 312 optionally normalizing the minimal coefficient representation determined using the quantum-based polynomial(s). In some embodiments, this may be performed using quantum amplitude encoding functionality in MATLAB, which can normalize rational number coefficients (such as those in Legendre polynomials) for realization in quantum logic.

The minimal coefficient representation is provided to a derivation function 314, which generally operates to process the minimal coefficient representation and generate a quantum gate logic design. For example, if an amplitude amplification algorithm is to be used as a quantum algorithm, qubits that form a set of qubits used in the amplitude amplification algorithm are orthonormal to each other, and amplitude amplification can be used to determine a subset of non-zero basis vectors that become a subspace of the qubits. Since a normalized Legendre polynomial or other normalized quantum polynomial may have been generated as discussed previously, it can be assumed that the corresponding qubits will have the same coefficients as the normalized quantum polynomial.

The derivation function 314 can use any suitable technique(s) to process minimal coefficient representations and generate quantum gate logic designs. In some embodiments, for example, an orthonormal set of qubits may be designed as follows. Assuming the availability of a normalized Legendre polynomial, for every pair of Legendre coefficients aLₖ and bLₖ₊₁, the coefficients can be normalized so that a²+b²=1 and so that | A [symbol] =a*|0 [symbol] +b*|1). Here, the notation |A [symbol] is used to denote a vector representation of a specified qubit A. In other embodiments, an even number of Legendre coefficients can be normalized so that the qubit corresponding to the Legendre coefficient aLₖ can be determined as |A [symbol] =a*|0 [symbol] +1−a²*|1). These types of approaches may, in some cases, be implemented using the quantum computer simulator in MATLAB.

Note that there are various types of quantum gates and various ways in which the quantum gates can be combined to produce desired functionalities. In some embodiments, various Pauli gates can be used as quantum gates in a quantum gate logic design. A Pauli gate generally calculates changes to the spin of a single electron. Because electron spin is one example property that can be used for a qubit in quantum gates, Pauli matrices and Pauli gates can be used to equate traditional logic gates with quantum gates. For instance, a Pauli X-gate corresponds to a classical NOT gate, so the Pauli X-gate is often called the quantum NOT gate. Specific examples of types of quantum gates that may be selected and used in a quantum gate logic design may include Pauli X-gates, Pauli Y-gates, Pauli Z-gates, Hadamard gates, phase shift gates, controlled NOT gates, controlled Z gates, swap gates, Toffoli gates, and Deutsch gates.

The quantum gate logic design is provided to a validation function 316, which generally operates to determine whether the quantum gate logic design is (at least functionally) equivalent to or better than the traditional combinatorial logic gate design. The validation function 316 here can be based on any suitable aspect or aspects of the quantum gate logic design and the traditional combinatorial logic gate design, such as when based on comparisons of inputs, outputs, numbers of gates, sizes, weights, processing powers, speeds, or any combination thereof.

In some cases, the validation function 316 may generate an estimated implementation of the traditional combinatorial logic gate design in an FPGA or other circuit, generate an estimated implementation of the quantum gate logic design in a quantum circuit, and compare one or more aspects of the two designs. Various tools (including tools for various FPGA manufacturers) may be used to generate the estimated implementation of the traditional combinatorial logic gate design in an FPGA. For example, the validation function 316 may generate a Very High Speed Integrated Circuits Program (VHSIC) hardware description Language (VHDL) file, other hardware description language (HDL) file, or other information describing a circuit. A synthesizer can be used to convert the VHDL/HDL file or other information into symbolic logic, and the same synthesizer or another synthesizer can map the symbolic logic to various FPGA primitives (such as lookup tables or flip-flips). An FPGA vendor tool can be used to place the FPGA primitives into a simulated FPGA device and to connect the FPGA primitives, and the FPGA vendor tool can be used to determine one or more characteristics of the resulting FPGA design (such as timing or power consumption).

Various approaches may also be used to generate the estimated implementation of the quantum gate logic design in a quantum circuit. Note that some caution can be taken when performing quantum simulations since it cannot always be assumed that qubits (such as A, B, C, and D) will be treated as perpendicular in general terms. As a result, the validation function 316 can make sure to generate quantum logic that forces A*B=0, A*C=0, etc. for the inner product spaces between any two qubits. As one particular example of this, it is possible to create a quantum design implementing Grover's algorithm using the Grover-master functionality available in MATLAB, such as by using the following code.

```
% prepare the Grover operator
  S0 = 2 * bs0 * bs0′ − eye(2\hat{ }n);
  G = kron(Hn * S0 * Hn, eye(2)) * query(n, x0);
% run the Grover's algorithm
  psi = G\hat{ }floor(pi / 4 * 2\hat{ }(n / 2)) * kron(Hn, H * X) * kron(bs0, [1 0]’);
```

To make a quantum circuit that acts as the quantum equivalent of a multi-dimensional mapping, Grover's algorithm can be generalized to the amplitude amplification algorithm. Since the architecture 300 is able to project quantum polynomials into orthonormal sets of qubits, it is possible to provide generalizations for various multi-qubit versions of the amplitude amplification algorithm. Note that it is possible to make a quantum circuit act as the quantum equivalent of a multi-dimensional mapping or other functionality by using or generalizing another algorithm (instead of Grover's algorithm), such as when the Variational Quantum Search (VQS) algorithm is used. In some cases, this can achieve exponential speedup, possibly by using Cayley graph representations. As a particular example, it is possible to define an XOR-AND-Inverter Graph (XAG) to specify Boolean functions and to use the XAG for quantum compilation. This type of approach would generally involve defining the XAG based on Boolean logic to be performed, designing a logic network based on the XAG, and identifying the resulting quantum circuit based on the logic network.

Assuming the quantum gate logic design is validated as being at least functionally equivalent to the traditional combinatorial logic gate design, an implementation function 318 can be used to actually implement the quantum gate logic design. In some cases, the implementation function 318 may be able to configure and reconfigure a photonic quantum circuit or other quantum circuit to achieve the quantum gate logic design. Note that the process performed by the architecture 300 can actually be iterative, such as when the entire process is repeated in order to dynamically update the photonic quantum circuit or other quantum circuit. This may be useful, for instance, to account for dynamic changing conditions in an environment.

It should be noted that the functions shown in or described with respect to FIG. 3 can be implemented in a server or other electronic device(s) in any suitable manner. For example, in some embodiments, at least some of the functions shown in or described with respect to FIG. 3 can be implemented or supported using one or more software applications 112 or other software instructions that are executed by the processing device(s) 202 of the application server 106 or other electronic device(s). In other embodiments, at least some of the functions shown in or described with respect to FIG. 3 can be implemented or supported using dedicated hardware components. In general, the functions shown in or described with respect to FIG. 3 can be performed using any suitable hardware or any suitable combination of hardware and software/firmware instructions. Also, the functions shown in or described with respect to FIG. 3 can be performed by a single electronic device or by multiple electronic devices.

Although FIG. 3 illustrates one example of a functional architecture 300 supporting gate reduction at distributed edge devices or other devices, various changes may be made to FIG. 3. For example, components or functions can be added, omitted, combined, further subdivided, replicated, rearranged, or placed in any other suitable configuration in the functional architecture 300 according to particular needs. Also, the functionality for supporting gate reduction at distributed edge devices or other devices may be used in any other suitable functional architecture(s). Although FIG. 4 illustrates one example of a representation 400 of a specific linear sequential machine in the form of a shift register, FIG. 4 does not limit the scope of this disclosure to any specific linear sequential machine or to any type of machine.

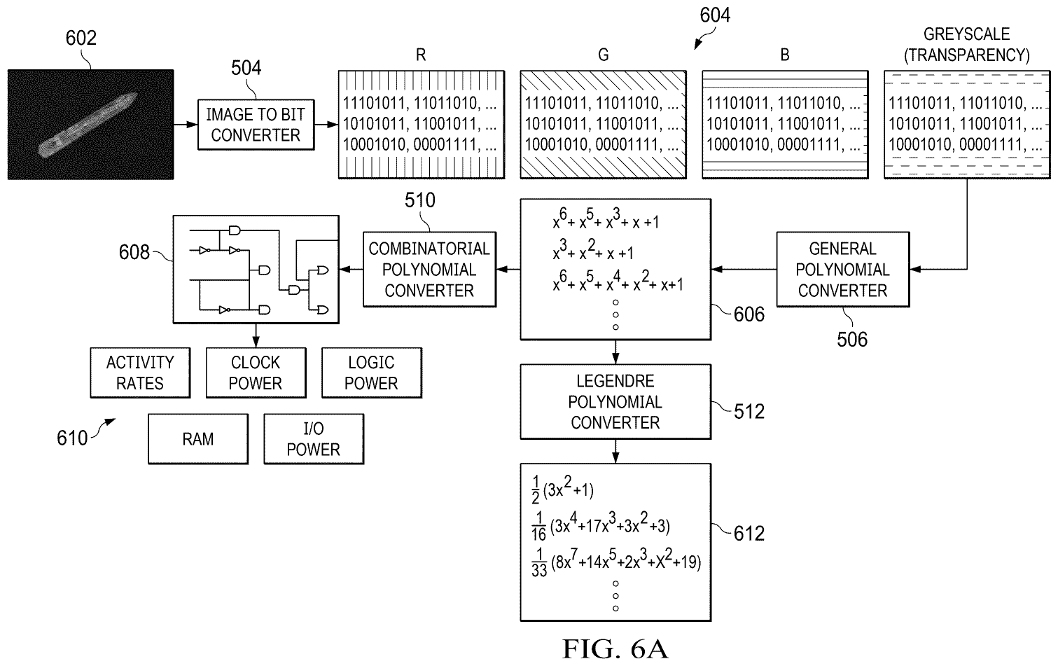

FIG. 5 illustrates an example functional architecture 500 supporting gate reduction at distributed edge devices or other devices in order to support a particular image processing function according to this disclosure. For ease of explanation, the functional architecture 500 shown in FIG. 5 may be described as being implemented on or supported by one or more components in the system 100 of FIG. 1, such as when the functional architecture 500 is implemented using the application server 106 (which itself may be implemented using one or more instances of the device 200 of FIG. 2). As a particular example, the functional architecture 500 may be implemented using one or more applications 112 executed by the processing device(s) 202 of the device(s) 200 forming the application server 106. However, the functional architecture 500 shown in FIG. 5 may be implemented on or supported by any suitable device(s) and in any suitable system(s). Various functions of the functional architecture 500 in FIG. 5 may be associated with corresponding functions of the functional architecture 300 in FIG. 3. For brevity, the descriptions of the functions in FIG. 3 are not repeated here.

As shown in FIG. 5, a collection function 502 generally operates to obtain imagery, such as one or more images of one or more scenes. Each image may represent an image to be processed during a search for a specified object of interest or a specified type of object of interest. As a particular example, the images may be processed as described below in order to determine whether the images capture a particular ship or a particular type of ship. Each image can have any suitable resolution and format. If necessary, a digitization function 504 can digitize each image, such as by converting each image into a comma-separated values (CSV) file or other digital file. Note that digitization may not be needed if the images are generated or otherwise obtained in a desired digital format. The image data can have any suitable bit depth, such as when each CSV or other digital file contains eight-bit data values or data values of other lengths. Depending on the implementation, each image may be associated with one or more files that include image data in one or more channels, such as in red, green, blue, and grayscale channels.

A creation function 506 generally operates to create a polynomial for each pixel of an image being processed. The order of each polynomial can be based on the bit length of each image data value, such as when eight-bit data values are associated with eighth-order polynomials. The coefficients of each polynomial can be based on the actual bit values of each image data value, such as when a “1” bit in an image data value corresponds to a “1” coefficient for the corresponding x term in the associated polynomial and a “0” bit in the image data value corresponds to a “0” coefficient for the corresponding x term in the associated polynomial. Thus, for instance, a “10010010” data value may be mapped to a polynomial of x⁸+x⁵+x²+1. In some cases, the image data from multiple channels can be combined into a single channel, and the resulting data values in the single channel can be used to generate the polynomial for each pixel. As a particular example, data values from multiple channels can be concatenated to produce resulting data values that are used to generate the polynomials for the pixels.

A creation function 508 generally operates to process the generated polynomials in order to select a subset of the polynomials representing the essential elements of information (EEI) for an image. In this example, the essential elements of information refer to the pieces of information that are needed or desired in order to make a determination whether an image contains an object of interest. In some cases, the subset of polynomials can be determined using a state machine that is designed to select the polynomials representing the essential elements of information based on the type of object in the image being processed. For instance, with respect to naval vessels, the essential elements of information may include the outline of a ship's hull and locations of certain immovable objects visible from above the ship.

Subsequent functions in FIG. 5 may be the same as or similar to various operations in FIG. 3. For example, the selected subset of polynomials can be provided to a creation function 510, which can be used to create a traditional combinatorial logic gate design. This may occur in the same or similar manner as the function 302 described above. A mapping function 512 may process the traditional combinatorial logic gate design in order to map the selected subset of polynomials representing the essential elements of information to orthonormal functions. This may occur in the same or similar manner as the functions 304-312 described above. Rational number coefficients of the orthonormal functions can be normalized for suitable realization in quantum logic by a normalization function 514. Example techniques for normalizing values are provided above. A derivation function 516 generates a quantum logic gate design based on the normalized orthonormal functions. This may occur in the same or similar manner as the function 314 described above. Implementations of the traditional combinatorial logic gate design and the quantum logic gate design are produced using a generation function 518, and the resulting quantum design is validated against the traditional combinatorial logic gate design by a validation function 520. This may occur in the same or similar manner as function 316 described above.

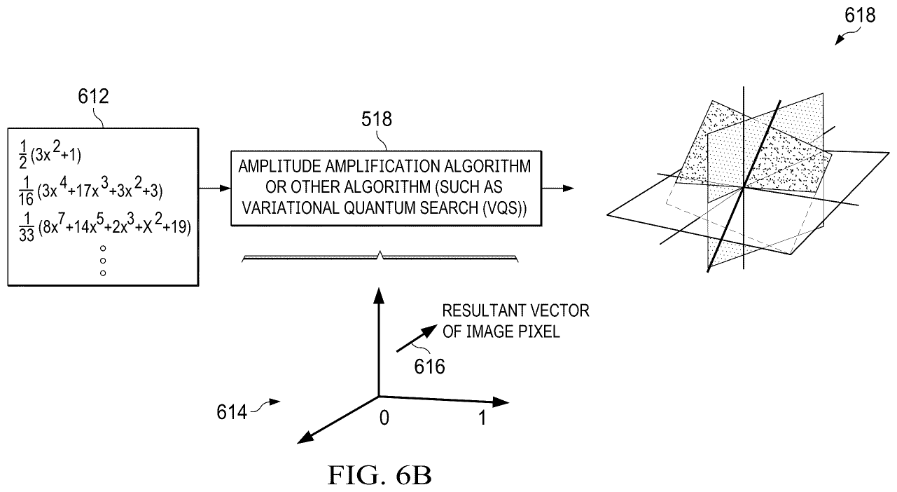

FIGS. 6A and 6B illustrate example operations in the architecture 500 of FIG. 5 according to this disclosure. As shown in FIG. 6A, an image 602 may be obtained, such as by the function 502 in the architecture 500. The image 602 is digitized, such as by the function 504 in the architecture 500, in order to generate digitized image data 604. In this example, the digitized image data 604 represents data in four channels. The digitized image data 604 is used by the function 506 in order to generate various polynomials 606, such as when the function 506 generates a polynomial 606 for each pixel in each channel or combines the image data (like via concatenation) and generates a polynomial 606 for the combined data. The function 510 can be used to process the polynomials 606 and generate a traditional combinatorial logic gate design 608. The traditional combinatorial logic gate design 608 is generally associated with one or more parameters 610 that can be identified based on the design or estimated operation of the traditional combinatorial logic gate design 608. In this example, the one or more parameters 610 include activity rates of different devices in the traditional combinatorial logic gate design 608; amounts of power used for clocking, logic devices, and I/O devices in the traditional combinatorial logic gate design 608; and amount of RAM in the traditional combinatorial logic gate design 608. Of course, any other or additional parameter(s) 610 or any other or additional combinations of parameters 610 may be used here.

The polynomials 606 are also processed by the function 512 in order to generate quantum polynomials 612, which in this example represent Legendre polynomials. As shown in FIG. 6B, the quantum polynomials 612 can be used to implement an amplitude amplification algorithm or other quantum algorithm, which can be used to process the images. In some cases, the amplitude amplification algorithm can use an identity matrix for computation, and the data from the various channels of the image 602 can be combined and overlaid relative to a “golden copy.” Here, the golden copy represents a known good image of an object of interest, and the image data of each image being processed can be compared to the golden copy in order to determine whether the image captures the object of interest. Here, the amplitude amplification algorithm generates a resultant vector 616, which can be scaled to have a length between zero and one. The resultant vector 616 can be defined within any suitable number of dimensions 614. While three dimensions are shown here, the resultant vector 616 may be defined within a larger number of dimensions 614, such as up to thirty-two dimensions 614 or even more. Outputs 618 from the amplitude amplification algorithm or other quantum algorithm in this example include a matching proximity factor, which defines how similar each pixel of an image is relative to the golden copy. This process can therefore be used to identify how closely the image being processed matches the golden copy, thereby providing an indication of whether the object of interest captured in the golden copy is also captured in the image being processed.

It should be noted that the functions shown in or described with respect to FIGS. 5 through 6B can be implemented in a server or other electronic device(s) in any suitable manner. For example, in some embodiments, at least some of the functions shown in or described with respect to FIGS. 5 through 6B can be implemented or supported using one or more software applications 112 or other software instructions that are executed by the processing device(s) 202 of the application server 106 or other electronic device(s). In other embodiments, at least some of the functions shown in or described with respect to FIGS. 5 through 6B can be implemented or supported using dedicated hardware components. In general, the functions shown in or described with respect to FIGS. 5 through 6B can be performed using any suitable hardware or any suitable combination of hardware and software/firmware instructions. Also, the functions shown in or described with respect to FIGS. 5 through 6B can be performed by a single electronic device or by multiple electronic devices.

Although FIG. 5 illustrates one example of a functional architecture 500 supporting gate reduction at distributed edge devices or other devices in order to support a particular image processing function, various changes may be made to FIG. 5. For example, components or functions can be added, omitted, combined, further subdivided, replicated, rearranged, or placed in any other suitable configuration in the functional architecture 500 according to particular needs. Also, the functionality for supporting gate reduction at distributed edge devices or other devices may be used in any other suitable functional architecture(s) and for any other suitable function(s). Although FIGS. 6A and 6B illustrate examples of operations in the architecture 500 of FIG. 5, various changes may be made to FIGS. 6A and 6B. For instance, the contents of the images being processed and the resulting polynomials can easily vary based on the scenes being imaged.

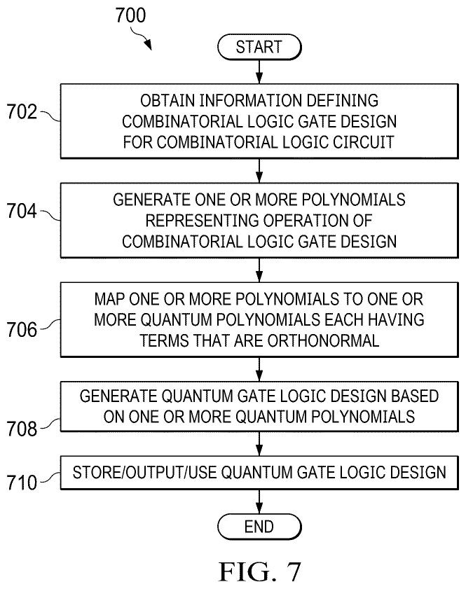

FIG. 7 illustrates an example method 700 for gate reduction at distributed edge devices or other devices according to this disclosure. For ease of explanation, the method 700 shown in FIG. 7 may be described as being performed using one or more components in the system 100 of FIG. 1, such as when the method 700 is performed using the application server 106 (which itself may be implemented using one or more instances of the device 200 of FIG. 2). As a particular example, the method 700 may be performed using one or more applications 112 executed by the processing device(s) 202 of the device(s) 200 forming the application server 106. However, the method 700 shown in FIG. 7 may be performed using any suitable device(s) and in any suitable system(s).

As shown in FIG. 7, information defining a combinatorial logic gate design for a combinatorial logic circuit is obtained at step 702. This may include, for example, the processing device 202 of the server 106 generating or otherwise obtaining information defining a traditional combinatorial logic gate design, such as a traditional gate design identifying combinatorial logic gates and their associated connections. The information may be obtained by the processing device 202 from an external source, generated by the processing device 202 using other information, or obtained in any other suitable manner.

One or more polynomials representing operation of the combinatorial logic gate design are generated at step 704. This may include, for example, the processing device 202 of the server 106 generating one or more polynomials representing the operation of the traditional combinatorial logic gate design. If the traditional combinatorial logic gate design is formed using multiple subcomponents, the processing device 202 may generate at least one polynomial for each subcomponent. In some cases, such as the approach shown in FIG. 5, the one or more polynomials may be generated based on pixels in image data and may optionally be reduced to a subset, such as a subset representing the essential elements of information for a specified application. Also, in some cases, the one or more polynomials representing the operation of the combinatorial logic gate design may be generated by generating a regular expression representing the operation of the combinatorial logic gate design, applying gate optimization to generate a reduced expression based on the regular expression, and generating the one or more polynomials representing the operation of the combinatorial logic gate design based on the reduced expression.

The one or more polynomials are mapped to one or more quantum polynomials at step 706. This may include, for example, the processing device 202 of the server 106 generating one or more Legendre or Laguerre polynomials or other orthonormal functions. Each quantum polynomial can have terms that are orthonormal to one another. This can optionally include the processing device 202 normalizing rational number coefficients of the orthonormal functions. In some cases, the one or more quantum polynomials can be mapped into Hilbert space, and a minimal coefficient representation of the combinatorial logic gate design in Hilbert space can be determined, such as by dropping terms from the one or more quantum polynomials having zeros as coefficients.

A quantum gate logic design is generated based on the one or more quantum polynomials at step 708. This may include, for example, the processing device 202 of the server 106 generating a quantum gate logic design based on the Legendre or Laguerre polynomials or other orthonormal functions as optionally normalized. As a particular example, this may include the processing device 202 using an XAG to specify Boolean functions to be performed, designing a logic network based on the XAG, and identifying a quantum circuit based on the logic network. The quantum gate logic design may be stored, output, or used in some manner at step 710. This may include, for example, the processing device 202 of the server 106 deploying the quantum gate logic design to a photonic quantum circuit or other quantum circuit. In some cases, this may include the processing device 202 of the server 106 implementing the quantum gate logic design in a quantum circuit for use in an edge device. As a particular example, the quantum circuit may be used to determine whether an object of interest as captured in a first image is present in a second image. Note, however, that the quantum gate logic design may be used in any other or additional manner.

Although FIG. 7 illustrates one example of a method 700 for gate reduction at distributed edge devices or other devices, various changes may be made to FIG. 7. For example, while shown as a series of steps, various steps in FIG. 7 may overlap, occur in parallel, occur in a different order, or occur any number of times (including zero times).

Note that the techniques described above can be used to implement extremely complicated algorithms and complex mathematical calculations to translate circuit designs between technology spaces, namely from traditional combinatorial logic gate design to quantum-based circuit design. In some cases, this can be accomplished in a lossless manner, meaning there is no information or capabilities lost in this translation. Among other things, with respect to the generation of an orthonormal polynomial representation, once the process goes beyond a handful of bits, the processing needed necessarily increases based on the complexity of the chosen orthonormal polynomials. Moreover, each of the coefficients of the orthonormal polynomials is a floating point number instead of an integer, and the mapping for each polynomial needs to carry the necessary precision to accurately represent a bit pattern as an orthonormal case that can be ingested into quantum circuitry. Because projection is being performed into a different polynomial space, all bits may be processed for the conversion to be accurate.

While part of this translation process includes the expression of a polynomial as a set of orthonormal polynomial functions, this is one aspect of the overall techniques, which can be highly complex. For instance, one example use case here is applying this unique translation to improve the size, weight, and power for real circuitry showing improvements from one dimension to the other (from traditional to quantum). As a particular example, consider the approach when used in conjunction with image processing to determine whether an object captured in one image is contained in another image. Among other things, the exacting precision of characterizing each pixel of an image such that a combinatorial polynomial may be derived for each pixel (coupled with the translation of each of those polynomials to a Legendre orthonormal polynomial function for which the rational number coefficients of Legendre polynomials can be normalized) followed by the mapping into quantum logic that can be realized with photonic gates or other quantum circuitry can be extremely complex.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining, using at least one processing device of an electronic device, information defining a combinatorial logic gate design for a combinatorial logic circuit;
generating, using the at least one processing device, one or more polynomials representing operation of the combinatorial logic gate design;
mapping, using the at least one processing device, the one or more polynomials to one or more quantum polynomials, each quantum polynomial having terms that are orthonormal; and
generating, using the at least one processing device, a quantum gate logic design based on the one or more quantum polynomials, the quantum gate logic design being functionally equivalent to or better than the combinatorial logic gate design for the combinatorial logic circuit.

2. The method of claim 1, wherein the one or more quantum polynomials are mapped into Hilbert space.

3. The method of claim 2, further comprising:
determining a minimal coefficient representation of the combinatorial logic gate design in Hilbert space by dropping terms from the one or more quantum polynomials having zeros as coefficients.

4. The method of claim 1, wherein generating the one or more polynomials representing the operation of the combinatorial logic gate design comprises:
generating a regular expression representing the operation of the combinatorial logic gate design;
applying gate optimization to generate a reduced expression based on the regular expression; and
generating the one or more polynomials representing the operation of the combinatorial logic gate design based on the reduced expression.

5. The method of claim 1, wherein:
obtaining the information defining the combinatorial logic gate design and generating the one or more polynomials representing the operation of the combinatorial logic gate design comprise:
obtaining an image comprising multiple pixels;
generating polynomials based on the pixels;
selecting a subset of the polynomials; and
using the subset of the polynomials to generate the combinatorial logic gate design; and
mapping the one or more polynomials to the one or more quantum polynomials comprises:
mapping the subset of the polynomials to orthonormal functions; and
normalizing rational number coefficients of the orthonormal functions.

6. The method of claim 1, further comprising:
implementing the quantum gate logic design in a quantum circuit for use in an edge device, the quantum circuit configured to determine whether an object of interest as captured in a first image is present in a second image.

7. The method of claim 1, wherein the quantum gate logic design is functionally equivalent to or better than the combinatorial logic gate design for the combinatorial logic circuit based on a comparison of at least one of: inputs, outputs, numbers of gates, sizes, weights, processing powers, or speeds.

8. An apparatus comprising:
at least one processing device configured to:
obtain information defining a combinatorial logic gate design for a combinatorial logic circuit;
generate one or more polynomials representing operation of the combinatorial logic gate design;
map the one or more polynomials to one or more quantum polynomials, each quantum polynomial having terms that are orthonormal; and
generate a quantum gate logic design based on the one or more quantum polynomials, the quantum gate logic design being functionally equivalent to or better than the combinatorial logic gate design for the combinatorial logic circuit.

9. The apparatus of claim 8, wherein the at least one processing device is configured to map the one or more quantum polynomials into Hilbert space.

10. The apparatus of claim 9, wherein the at least one processing device is further configured to drop terms from the one or more quantum polynomials having zeros as coefficients and determine a minimal coefficient representation of the combinatorial logic gate design in Hilbert space.

11. The apparatus of claim 8, wherein, to generate the one or more polynomials representing the operation of the combinatorial logic gate design, the at least one processing device is configured to:
generate a regular expression representing the operation of the combinatorial logic gate design;
apply gate optimization to generate a reduced expression based on the regular expression; and
generate the one or more polynomials representing the operation of the combinatorial logic gate design based on the reduced expression.

12. The apparatus of claim 8, wherein:
to obtain the information defining the combinatorial logic gate design and generate the one or more polynomials representing the operation of the combinatorial logic gate design, the at least one processing device is configured to:
obtain an image comprising multiple pixels;
generate polynomials based on the pixels;
select a subset of the polynomials; and
use the subset of the polynomials to generate the combinatorial logic gate design; and
to map the one or more polynomials to the one or more quantum polynomials, the at least one processing device is configured to:
map the subset of the polynomials to orthonormal functions; and
normalize rational number coefficients of the orthonormal functions.

13. The apparatus of claim 8, wherein the at least one processing device is further configured to implement the quantum gate logic design in a quantum circuit for use in an edge device, the quantum circuit configured to determine whether an object of interest as captured in a first image is present in a second image.

14. The apparatus of claim 8, wherein the quantum gate logic design is functionally equivalent to or better than the combinatorial logic gate design for the combinatorial logic circuit based on a comparison of at least one of: inputs, outputs, numbers of gates, sizes, weights, processing powers, or speeds.

15. A non-transitory machine readable medium containing instructions that when executed cause at least one processor to:
obtain information defining a combinatorial logic gate design for a combinatorial logic circuit;
generate one or more polynomials representing operation of the combinatorial logic gate design;
map the one or more polynomials to one or more quantum polynomials, each quantum polynomial having terms that are orthonormal; and
generate a quantum gate logic design based on the one or more quantum polynomials, the quantum gate logic design being functionally equivalent to or better than the combinatorial logic gate design for the combinatorial logic circuit.

16. The non-transitory machine readable medium of claim 15, wherein the instructions when executed cause the at least one processor to map the one or more quantum polynomials into Hilbert space.

17. The non-transitory machine readable medium of claim 16, further containing instructions that when executed cause the at least one processor to drop terms from the one or more quantum polynomials having zeros as coefficients and determine a minimal coefficient representation of the combinatorial logic gate design in Hilbert space.

18. The non-transitory machine readable medium of claim 15, wherein the instructions that when executed cause the at least one processor to generate the one or more polynomials representing the operation of the combinatorial logic gate design comprise instructions that when executed cause the at least one processor to:
generate a regular expression representing the operation of the combinatorial logic gate design;
apply gate optimization to generate a reduced expression based on the regular expression; and
generate the one or more polynomials representing the operation of the combinatorial logic gate design based on the reduced expression.

19. The non-transitory machine readable medium of claim 15, wherein:
the instructions that when executed cause the at least one processor to obtain the information defining the combinatorial logic gate design and generate the one or more polynomials representing the operation of the combinatorial logic gate design comprise instructions that when executed cause the at least one processor to:
obtain an image comprising multiple pixels;
generate polynomials based on the pixels;
select a subset of the polynomials; and
use the subset of the polynomials to generate the combinatorial logic gate design; and
the instructions that when executed cause the at least one processor to map the one or more polynomials to the one or more quantum polynomials comprise instructions that when executed cause the at least one processor to:
map the subset of the polynomials to orthonormal functions; and
normalize rational number coefficients of the orthonormal functions.

20. The non-transitory machine readable medium of claim 15, further containing instructions that when executed cause the at least one processor to implement the quantum gate logic design in a quantum circuit for use in an edge device, the quantum circuit configured to determine whether an object of interest as captured in a first image is present in a second image.

21. An edge device comprising:
a quantum circuit implementing a quantum gate logic design for a combinatorial logic circuit based on one or more quantum polynomials, each quantum polynomial having terms that are orthonormal;
wherein the one or more quantum polynomials have been mapped to one or more polynomials representing operation of the combinatorial logic gate design for the combinatorial logic circuit; and
wherein the quantum gate logic design is functionally equivalent to or better than the combinatorial logic gate design for the combinatorial logic circuit.
